(19) United States
(12) Patent Application Publication
(10) Pub. No.: US 2007/0091756 A1
(43) Pub. Date: Apr. 26, 2007

(54) METHOD AND APPARATUS OF CALIBRATING PARAMETERS UTILIZED FOR DETERMINING SERVO SIGNALS

(76) Inventors: Chi-Jui Lee, Tao-Yuan City (TW); Shih-Hao Ko, Tai-Chung Hsien (TW); Chun-Jen Chen, Kao-Hsiung Hsien (TW); Hsu-Feng Ho, Taipei City (TW); Yung-Chi Shen, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/163,575

(22) Filed: Oct. 24, 2005

(51) Int. Cl. G11B 27/36

(52) U.S. Cl. 369/53.34

(57) ABSTRACT

A method and related apparatus for calibrating at least a parameter utilized for determining a servo signal of an optical disc drive. The method includes: (a) adjusting the parameter; (b) generating a first signal according to detecting signals outputted from one side of a photo detector; (c) generating a second signal according to detecting signals outputted from the other side of the photo detector; (d) generating an index value according to the first and second signals; and (e) if a criterion for the index value is satisfied, utilizing the parameter corresponding to the index as an optimum parameter for the servo signal.

### BACKGROUND

The present invention relates to a method and apparatus of calibrating servo signals, and more particularly, to a method and apparatus of calibrating parameters used for determining servo signals.

Optical storage medium, such as a DVD, is currently a very popular type of storage medium. FIG. 1 shows a block diagram of a conventional optical disc drive 100. The optical disc drive (e.g. a DVD drive) 100 has a pick-up unit 110 utilized to access an optical disc 101 for reading data from the optical disc 101 or recording data onto the optical disc 101 or both reading and writing data from and onto the optical disc 101. The pick-up unit 110 includes a laser diode 112 utilized for emitting a laser beam with a specific laser power onto a track of the optical disc 101 and a photo detector 114 utilized for detecting the laser beam reflected from the optical disc 101 to generate a plurality of detecting signals: A, B, C, and D. It is well known to those skilled in this art, that the photo detector 114 generally has four sensing areas: 115ₐ, 115_{b}, 115_{c}, and 115_{d}. These four sensing areas are utilized for outputting detecting signals: A, B, C, and D respectively. The servo signal generator 140 functions as a signal synthesizer for synthesizing the detecting signals: A, B, C, and D to generate the desired servo signals. Servo signals include various signals. For example, one of these signals is called a tracking error signal TE. The TE signal represents the position-offset component of the laser spot with respect to the target track on the optical disc 101. Another signal is called a focusing error signal FE. The FE signal represents the focus-offset component of the laser spot with respect to the target layer of the optical disc 101.

A servo controller 160 sends a tracking servo output signal TRO and a focus servo output signal FOO to an actuator 170 based on the tracking error signal TE and the focusing error signal FE. The actuator 170, based on the control signals received from the servo controller 160, moves the pick-up unit 110 horizontally and vertically to minimize both the tracking error and the focusing error.

The operation of the optical drive 100 causes the optical disc 101 to be rotated at a very high speed. The operating characteristics of the optical disc 101 in such circumstances are prone to be highly temperature-dependent and external-force-dependent. In addition, due to the optical disc 101 being a detachably installed recording carrier, the rotating center of the optical disc 101 may deviate from the predetermined center of rotation. As a result, the optical disc 101 may operate in an unstable condition. This unstable operation may result in causing the focusing error and tracking error as described earlier. Moreover, the optical disc 101 shown in FIG. 1 is utilized to store high-density data. In the case of high-density data storage, the width of the data tracks and the distance between the data tracks are both reduced. Therefore, any laser spot deviation from the data track will lead to incorrect data accessing (reading or recording). Therefore, it is critical that the pick-up unit 110 be required to lock the laser spot along the desired data track on the optical disc 101 to accurately and quickly access data.

However, the variations in the different layers of the optical disc 101 cause difficulty in proper servo control. The substrate thickness of the optical disc 101 often varies from disc to disc. The substrate thickness of a single optical disc 101 often varies even within that disc from layer to layer. Therefore, the servo signals are hardly optimized because of the different layer characteristic of the optical disc 101. In addition, it is not guaranteed that each optical disc has been manufactured according to what might be considered perfect specifications. For example, the dye may not be uniformly spread on each layer of the optical disc 101. Therefore, within the same layer of the optical disc 101, the characteristic of an inner track might differ from that of an outer track. This phenomenon further increases the difficulty in servo signal calibration.

As mentioned above, the pick-up unit 110 is a key component for accessing the optical disc 101. Taking data recording of a dual-layer DVD for example, a complex pick-up unit 110 is required, which makes the optical path of the laser beam shift with the power increment. Please refer to FIG. 2 in conjunction with FIG. 3. FIG. 2 is a diagram illustrating the power distribution on the photo detector 114 shown in FIG. 1. FIG. 3 is a diagram illustrating the laser spot shift on the photo detector 114 shown in FIG. 1. If the laser diode 112 shown in FIG. 1 increases the laser power, the power of the reflected laser beam becomes greater, and the optical path deviation occurs as a result. As shown in FIG. 2, the center of the power distribution curve is forced from C to C′ as the laser power is increased. This movement causes the laser spot 116, shown in FIG. 3, to shift leftward on the photo detector 114. The laser spot shift induces a great impact on the tracking control further jeopardizing the recording quality.

The conventional optical disc drive 100 fails to compensate for these above-mentioned factors that deteriorate the servo control accuracy. Therefore, the method to compensate for these above-mentioned factors to improve performance of the optical disc drive becomes an important issue in the manufacture of the optical disc drive.

### SUMMARY

It is one of the objectives of the present invention to provide a method for servo calibration of an optical disc drive to solve the above-mentioned problems.

According to an aspect of the present invention, a method for calibrating a parameter used for determining a servo signal of an optical disc drive is disclosed, the method comprises: (a) adjusting the parameter; (b) generating a first signal according to detecting signals outputted from one side of a photo detector; (c) generating a second signal according to detecting signals outputted from the other side of the photo detector; (d) generating an index value according to the first and second signals; and (e) if a criterion for the index value is satisfied, then utilizing the parameter corresponding to the index as an optimum parameter for the servo signal.

According to another aspect of the present invention, a method for calibrating a parameter used for determining a servo signal of an optical disc drive is disclosed, the method comprises: disabling a tracking control; measuring the servo signal when the tracking control is disabled; and calibrating the parameter according to the measured servo signal.

According to another aspect of the present invention, a method for calibrating a parameter used for determining a servo signal of an optical disc drive is disclosed, the method comprises: (a) adjusting the parameter; (b) reading data from an optical disc; (c) generating an index value according to the data; and (d) if a criterion for the index value is satisfied, then utilizing the parameter corresponding to the index as an optimum parameter for the servo signal.

According to another aspect of the present invention, a method for calibrating parameters for a servo signal of an optical disc drive is disclosed, the method comprises: (a) calibrating a first parameter for the servo signal when the optical disc drive accesses a first layer of an optical disc; and (b) calibrating a second parameter for the servo signal when the optical disc drive accesses a second layer of an optical disc.

According to another aspect of the present invention, a method for calibrating parameters for a servo signal of an optical disc drive is disclosed, the method comprises: calibrating a first parameter for the servo signal when the optical disc drive accesses a first track of an optical disc; and calibrating a second parameter for the servo signal when the optical disc drive accesses a second track of the optical disc.

The present invention is capable of calibrating servo parameters (e.g., the TE offset, the FE offset, and the loop gain of the servo control) for a plurality of layers and calibrating servo parameters for a plurality of positions on the same layer. In other words, when recording user data onto a specific track of a specific layer, proper servo parameters are used to compensate the servo control mechanism for the non-uniform die layer of the optical disc or the optical path deviation caused by the power increment. To sum up, the optical disc drive and related servo parameter calibration method of the present invention greatly improve the recording quality and the recording performance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a block diagram of a conventional optical disc drive.

FIG. 2 shows a diagram illustrating the power distribution on the photo detector shown in FIG. 1.

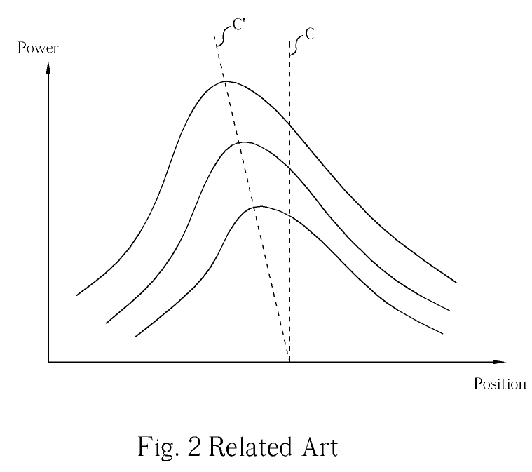

FIG. 3 shows a diagram illustrating the laser spot shift on the photo detector shown in FIG. 1.

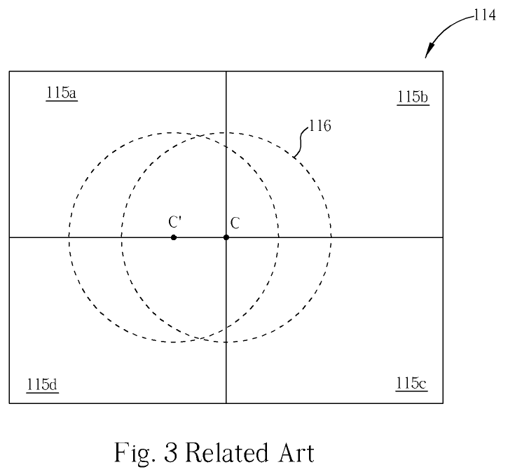

FIG. 4 shows a block diagram of an optical disc drive according to a first embodiment of the present invention.

FIG. 5 shows a diagram illustrating the definition of a balance index BI used by the calibrating circuit.

FIG. 6 shows a flowchart illustrating the operation of calibrating the parameters FE offset and Kb as performed by the optical disc drive as shown in FIG. 4.

FIG. 7 shows a block diagram of an optical disc drive according to a second embodiment of the present invention.

FIG. 8 shows a flowchart illustrating the operation of calibrating the parameters FE offset and Kb performed by the optical disc drive as shown in FIG. 7.

FIG. 9 shows a block diagram of an optical disc drive according to a third embodiment of the present invention.

FIG. 10 shows a block diagram of an optical disc drive according to a fourth embodiment of the present invention.

FIG. 11 shows a flowchart illustrating operation of tuning the TE offset performed by the optical disc drive shown in FIG. 10.

FIG. 12 shows a block diagram of an optical disc drive according to a fifth embodiment of the present invention.

FIG. 13 shows a flowchart illustrating operation of tuning the TE offset performed by the optical disc drive shown in FIG. 12.

FIG. 14 shows a block diagram of an optical disc drive according to a sixth embodiment of the present invention.

FIG. 15 shows a block diagram illustrating an optical disc drive according to a seventh embodiment of the present invention.

FIG. 16 shows a flowchart illustrating operation of determining the TE offset off-line.

### DETAILED DESCRIPTION

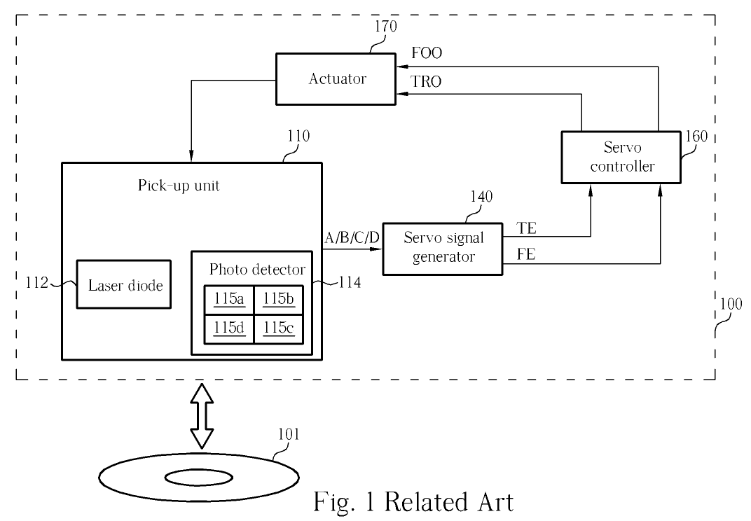

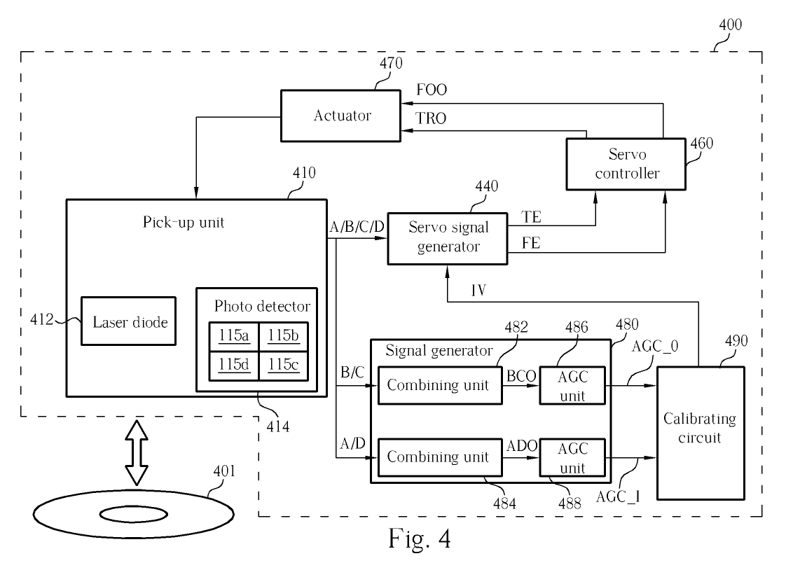

Please refer to FIG. 4, which is a block diagram of an optical disc drive 400 according to a first embodiment of the present invention. Since the elements of the same name in the FIG. 4 and FIG. 1 have the same function and operation, detailed description is omitted for the sake of brevity.

In this embodiment, in order to compensate the focusing error signal FE, an offset is utilized to adjust the servo control operation. For example, the servo signal generator 440 generates the focusing error signal FE by synthesizing the detecting signals: A, B, C, and D according to the following equation.
FE=(A+C)−Kb*(B+D)+FE offset

Please note, Kb is a parameter value that is used to adjust the ratio between the sum of the detecting signals A and C and the sum of the detecting signals B and D. In an effort to optimize the focusing control, the parameter values Kb and FE offset should be properly calibrated. Therefore, the optical disc drive 400 includes a signal generator 480 and a calibrating circuit 490 to tune these two parameter values Kb and FE offset. In other words, the servo signal generator 440 adjusts the parameter set including the two parameters FE offset and Kb according to a calibration setting IV that is outputted from the calibrating circuit 490. Then, the servo signal generator 440 generates the focusing error signal FE according to the updated parameter set.

As shown in FIG. 4, the signal generator 480 can be applied by a wobble signal reproducing circuit. The wobble signal reproducing circuit is utilized to transfer the pre-grooved wobble on disk to corresponding electric signal. the signal generator 480 includes two combining units 482, 484 and two auto gain control (AGC) units 486, 488. The combining unit 482 sums the detecting signals B and C. By summing the detecting signals B and C, the combining unit 482 thereby outputs a signal BCO. Then, the AGC unit 486 applies a specific gain to the signal BCO for generating an output signal AGC_O. Similarly, the combining unit 484 sums the detecting signals A and D. By summing the detecting signals A and D, the combining unit 484 thereby outputs a signal ADO. Then, the AGC unit 488 applies a specific gain to the signal ADO for generating an output signal AGC_I. Please note that in this embodiment the signal generator 480 is part of a wobble signal reproducing circuit. This configuration thereby reduces the implementation cost of calibrating the parameters FE offset and Kb.

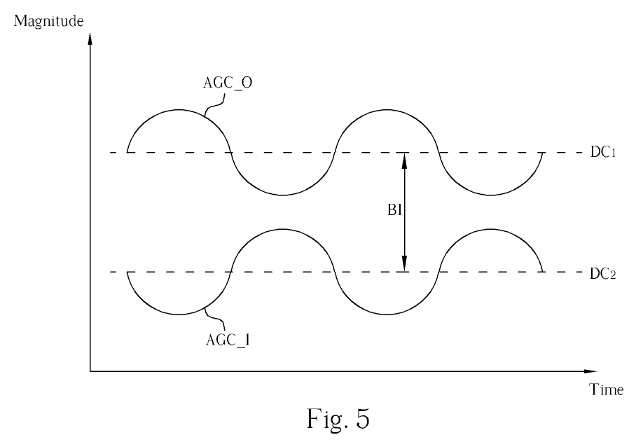

In this embodiment, the calibrating circuit 490 activates a calibration process to tune the parameter set adopted by the servo signal generator 440. During the calibration process, the calibrating circuit 490 calculates a balance index for each parameter set. Please refer to FIG. 5, which is a diagram illustrating the definition of a balance index BI used by the calibrating circuit 490. After receiving the incoming output signals AGC_O and AGC_I, the calibrating circuit 490 first determines DC levels DC₁ and DC₂ of these output signals AGC_O and AGC_I, and then determines a balance index BI according to the difference between the DC levels DC₁ and DC₂. A smaller balance index BI will result in a more optimum parameter set. Based on this rule, the operation of calibrating the parameters FE offset and Kb is detailed as follows.

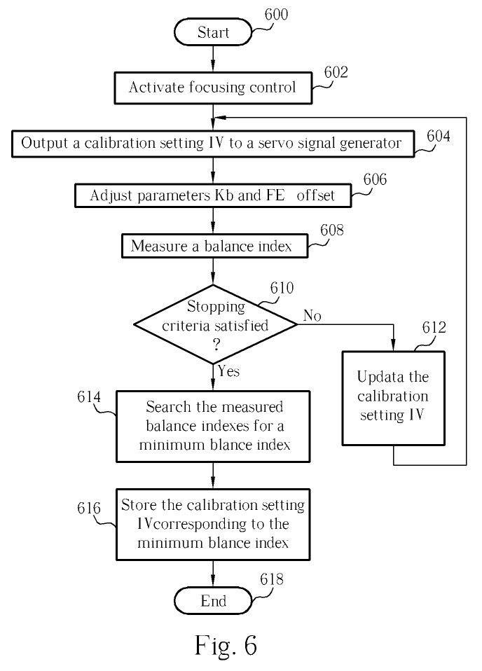

Please refer to FIG. 6, which is a flowchart illustrating the operation of calibrating the parameters FE offset and Kb as performed by the optical disc drive 400 as shown in FIG. 4. The operation of calibrating the parameters FE offset and Kb includes following steps:

Step 600: Start.

Step 602: The servo controller 460 activates the closed-loop focusing control to minimize the focusing error.

Step 604: The calibrating circuit 490 outputs a calibration setting IV to the servo signal generator 440.

Step 606: The servo signal generator 440 adjusts the parameters Kb and FE offset according to the received calibration setting IV.

Step 608: The calibrating circuit 490 measures a balance index BI corresponding to the current calibration setting IV.

Step 610: Is the stopping criterion satisfied? If yes, go to step 614; otherwise, go to step 612.

Step 612: The calibrating circuit 490 updates the calibration setting IV. Go to step 604.

Step 614: The calibrating circuit 490 searches the measured balance indexes for a minimum balance index.

Step 616: The calibrating circuit 490 stores the calibration setting IV corresponding to the minimum balance index.

Step 618: End.

In this embodiment, the stopping criterion in step 610 is that the number of the measured balance indexes has reached a predetermined value. However, the stopping criteria are not limited to the above definition. That is, in other embodiments, the stopping criterion can be assigned by different conditions depending on design requirements. As mentioned above, this embodiment delivers the output signals AGC_O and AGC_I into the calibrating circuit 490 for measuring the balance index. However, as is known to those skilled in this art, the AGC units 486, 488 merely adjust amplitude of the incoming signals BCO and ADO. The DC levels of these two signals BCO and ADO are substantially the same as that of the output signals AGC_O and AGC_I. Therefore, the calibrating circuit 490 is allowed to use the signals BCO and ADO instead of the output signals AGC_O and AGC_I when calculating the balance index. The same objective of obtaining the balance index in achieved.

Please note that the flow shown in FIG. 6 is not limited to calibrating parameters Kb and FE offset of a single layer. For example, assuming that the optical disc 401 is a multi-layer DVD and using the same calibration process, the calibrating circuit 490 is capable of calibrating the parameters Kb and FE offset for each layer, respectively. For example, after the parameters Kb and FE offset for a first layer have been properly calibrated, a second layer is selected, and the identical flow as shown in FIG. 6 is applied again to calibrate the parameters Kb and FE offset for the second layer. Moreover, the flow shown in FIG. 6 is not limited to calibrate parameters Kb and FE offset of one layer once. Using the identical calibration process, the calibrating circuit 490 is capable of calibrating the parameters Kb and FE offset for different positions on the same layer, respectively. For example, after the parameters Kb and FE offset for a first position (e.g., an inner track) on a layer have been properly calibrated, a second position (e.g., an outer track) on the same layer is selected and the identical flow as shown in FIG. 6 is performed again to calibrate the parameters Kb and FE offset for the second position.

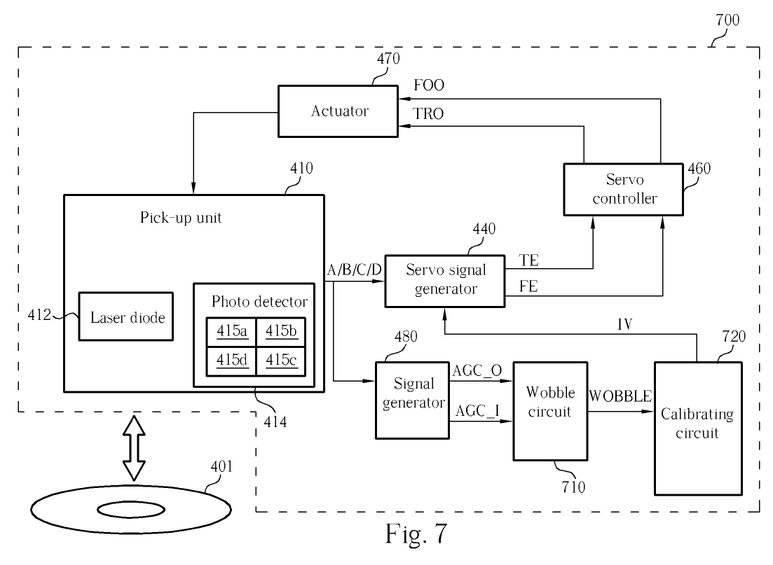

Please refer to FIG. 7. FIG. 7 shows a block diagram of an optical disc drive 700 (e.g., a DVD drive) according to a second embodiment of the present invention. Since the elements having the same name in the first embodiment as those in the second embodiment also have the same function and operation, further description is omitted for the sake of brevity. The key difference between the first and second embodiments is that the calibrating circuit 720 determines the balance index according to a wobble signal WOBBLE generated from the wobble circuit 710 instead of the difference between the DC levels of the output signals AGC_O and AGC_I. In this embodiment, a greater balance index will result in a more optimum the parameter set. Based on this rule, the operation of calibrating the parameters FE offset and Kb is detailed as follows.

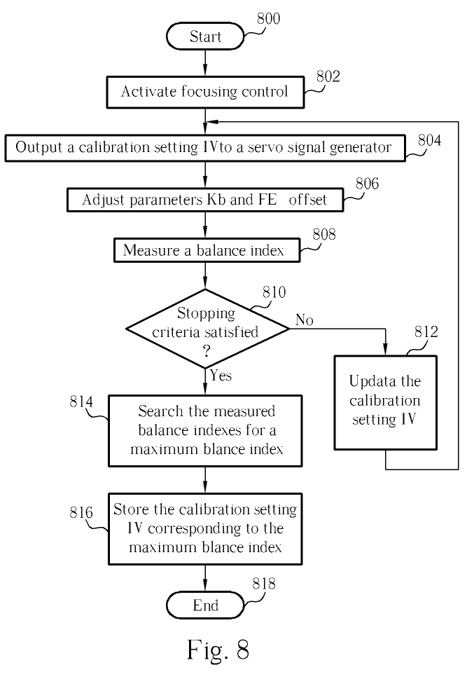

Please refer to FIG. 8, which is a flowchart illustrating the operation of calibrating the parameters FE offset and Kb performed by the optical disc drive 700 as shown in FIG. 7. The operation of calibrating the parameters FE offset and Kb includes following steps:

Step 800: Start.

Step 802: The servo controller 460 activates the closed-loop focusing control to minimize the focusing error.

Step 804: The calibrating circuit 720 outputs a calibration setting IV to the servo signal generator 440.

Step 806: The servo signal generator 440 adjusts the parameters Kb and FE offset according to the received calibration setting IV.

Step 808: The calibrating circuit 720 measures a balance index BI corresponding to the current calibration setting IV.

Step 810: Is the stopping criterion satisfied? If yes, go to step 814; otherwise, go to step 812.

Step 812: The calibrating circuit 720 updates the calibration setting IV. Go to step 804.

Step 814: The calibrating circuit 720 searches the measured balance indexes for a maximum balance index.

Step 816: The calibrating circuit 720 stores the calibration setting IV corresponding to the maximum balance index.

Step 818: End.

In this embodiment, the stopping criterion in step 810 is that the number of the measured balance indexes has reached a predetermined value. However, the stopping criteria are not limited to the above definition. That is, in other embodiments, the stopping criterion can be assigned by different conditions depending on design requirements. In addition, the flow shown in FIG. 8 is not limited to calibrate parameters Kb and FE offset of a single layer. Assume that the optical disc 401 is a multi-layer DVD. Using the same calibration process, the calibrating circuit 720 is capable of calibrating the parameters Kb and FE offset for each layer, respectively. For example, after the parameters Kb and FE offset for a first layer have been properly calibrated, a second layer is selected, and the same flow as shown in FIG. 8 is performed again to calibrate the parameters Kb and FE offset for the second layer. Moreover, the flow as shown in FIG. 8 is not limited to calibrate parameters Kb and FE offset of one layer once. Using the same calibration process, the calibrating circuit 720 is capable of calibrating the parameters Kb and FE offset for different positions on the same layer, respectively. For example, after the parameters Kb and FE offset for a first position (e.g., an inner track) on a layer have been properly calibrated, a second position (e.g., an outer track) on the same layer is selected and the same flow shown in FIG. 8 is performed again to calibrate the parameters Kb and FE offset for the second position.

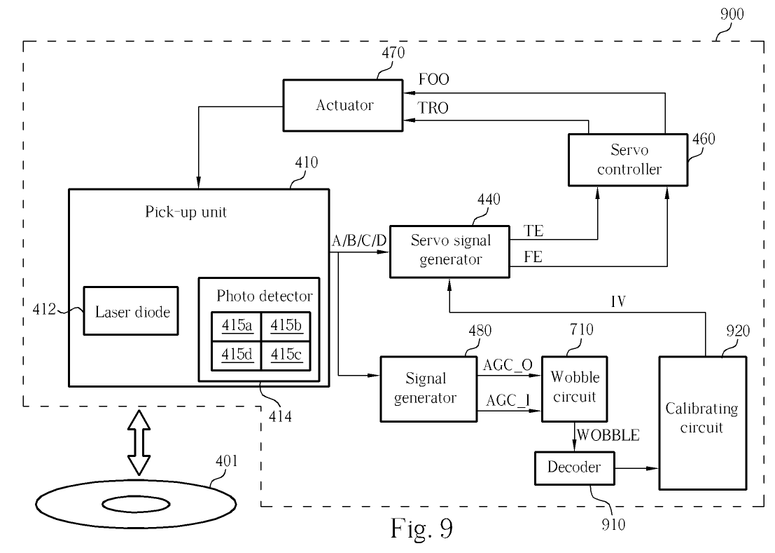

Please refer to FIG. 9. FIG. 9 shows a block diagram of an optical disc drive 900 (e.g., a DVD drive) according to a third embodiment of the present invention. Since the elements having the same name in the first, second, and third embodiments have the same function and operation, further description is omitted for the sake of brevity. The key difference between the first and third embodiments is that the calibrating circuit 920 determines the balance index according to information provided by the decoder 910 instead of the difference between the DC levels of the output signals AGC_O and AGC_I. In other words, the calibrating circuit 920 sets the balance index corresponding to a specific parameter set (e.g., Kb and FE offset) adopted by the servo signal generator according to the error rate of the decoder 910 decoding the wobble signal WOBBLE. In this embodiment, a smaller balance index results in a more optimum parameter set. Based on this rule, the operation of calibrating the parameters FE offset and Kb is identical to the flow as shown in FIG. 6, which searches the measured balance indexes for a minimum balance index to find out the optimum setting to the parameters Kb and FE offset.

Similarly, this embodiment, which uses the decoding error rate to determine the balance index, is not limited to calibrate parameters Kb and FE offset of a single layer. Assume that the optical disc 401 is a multi-layer DVD. Using the same calibration process, the calibrating circuit 920 is capable of calibrating the parameters Kb and FE offset for each layer, respectively. Moreover, this embodiment is not limited to calibrate parameters Kb and FE offset of one layer once. Using the same calibration process, the calibrating circuit 920 is capable of calibrating the parameters Kb and FE offset for different positions on the same layer, respectively. For example, after the parameters Kb and FE offset for a first position (e.g., an inner track) on a layer have been properly calibrated, a second position (e.g., an outer track) on the same layer is selected and the calibration process is performed again to calibrate the parameters Kb and FE offset for the second position.

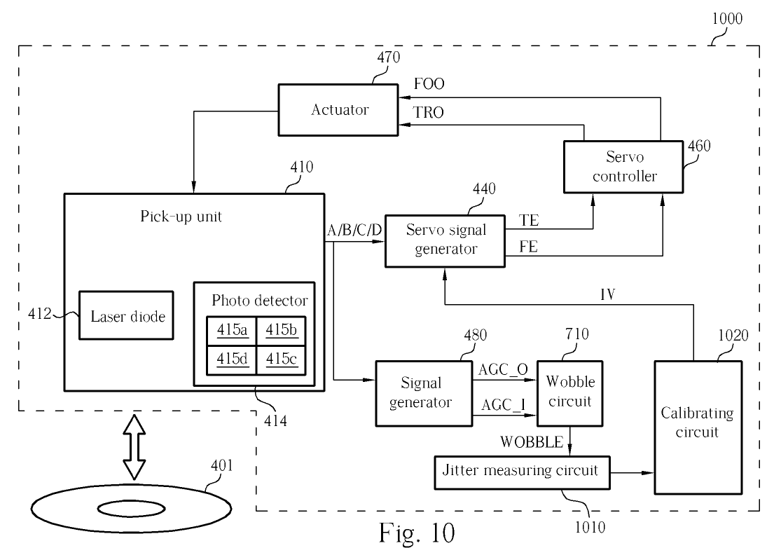

As to calibrating parameters for the tracking error signal TE, the present invention brings up a new calibration scheme. Please refer to FIG. 10. FIG. 10 shows a block diagram of an optical disc drive 1000 (e.g., a DVD drive) according to a fourth embodiment of the present invention. Since the elements of the same name in the second and fourth embodiments have the same function and operation, further description is omitted for the sake of brevity. Compared to the circuit architecture shown in FIG. 7, the optical disc drive 1000 shown in FIG. 10 further includes a jitter measuring circuit (jitter meter) 1010 used for measuring jitter of the wobble signal WOBBLE outputted from the wobble circuit 710. In this embodiment, a TE offset is utilized by the servo signal generator 440 to compensate the tracking error signal TE. In an effort to optimize the tracking control, the TE offset should be properly calibrated. Therefore, the calibrating circuit 1020 cooperates with the jitter measuring circuit 1010 to tune the TE offset set to the servo signal generator 440.

During the calibration process, the calibrating circuit 1020 calculates a tuning index for each TE offset set to the servo signal generator 440 according to the calibration setting IV. As shown in FIG. 10, the jitter information provided by the jitter measuring circuit 1010 is utilized by the calibrating circuit 1020 to set the tuning index. As the tuning index becomes smaller the TE offset approaches its optimum value. Based on this rule, the operation of calibrating the parameters for the tracking error signal TE (e.g., the TE offset) is detailed as follows.

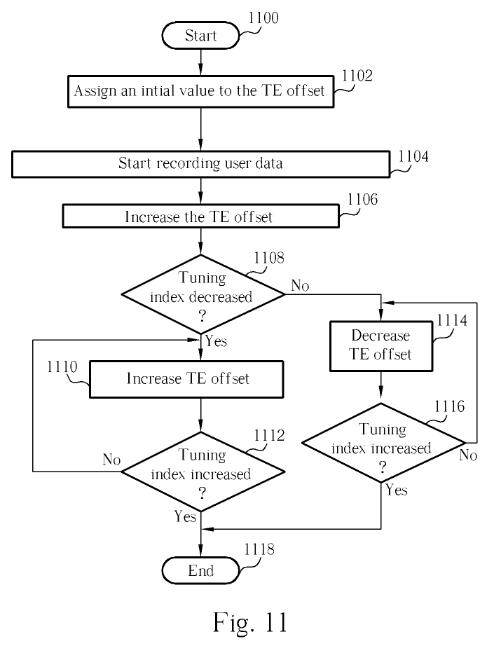

Please refer to FIG. 11, which is a flowchart illustrating operation of tuning the TE offset performed by the optical disc drive 1000 shown in FIG. 10. Tuning the TE offset includes following steps:

Step 1100: Start.

Step 1102: Assign an initial value to the TE offset.

Step 1104: Start recording user data.

Step 1106: Increase the TE offset.

Step 1108: Is the tuning index decreased? If yes, go to step 1110; otherwise, go to step 1114.

Step 1110: Increase the TE offset.

Step 1112: Is the tuning index increased? If yes, go to step 1118; otherwise, go to step 1110.

Step 1114: Decrease the TE offset.

Step 1116: Is the tuning index increased? If yes, go to step 1118; otherwise, go to step 1114.

Step 1118: End.

According to the above flow, it is designed to find a minimum tuning index so as to determine an optimum TE offset during the data recording process. For example, if step 1108 finds that the tuning index is decreased as the TE offset is increased, it means that the current TE offset should be tuned upwards. Therefore, the calibrating circuit 1020 keeps outputting the calibration setting IV to the servo signal generator 440 to gradually increase the TE offset, causing the tuning index to be gradually reduced (steps 1110 and 1112). The TE offset becomes the desired TE offset when the tuning index is not decreased any more and begins to be increased. At this moment, the optimum TE offset is determined according to the calibrating circuit 1020. On the contrary, if step 1108 finds that the tuning index is increased as the TE offset is increased, it means that the current TE offset should be tuned downwards. Therefore, the calibrating circuit 1020 keeps outputting the calibration setting IV to the servo signal generator 440 to gradually decrease the TE offset, causing the tuning index to be gradually reduced (steps 1114 and 1116). The TE offset becomes the desired TE offset when the tuning index is not decreased any more and begins to be increased. At this moment, the optimum TE offset is determined according to the calibrating circuit 1020.

In short, the flow of calibrating the TE offset firstly determines how to tune the TE offset for making the tuning index smaller. As mentioned above, the optimum TE offset corresponds to the minimum tuning index. Therefore, if the flow of calibrating the TE offset finds that the tuning index is reduced as the TE offset is increased or the tuning index is increased as the TE offset is decreased, it determines when the optimum TE offset occurs by monitoring the tuning index; and if the flow of calibrating the TE offset finds that the tuning index is reduced as the TE offset is increased or the tuning index is increased as the TE offset is decreased, it determines when the optimum TE offset occurs by monitoring the tuning index. Based on the above rules, the flow shown in FIG. 11 can be modified to achieve the same objective of locating the optimum TE offset. For example, step 1106 could be replaced by a step of decreasing the TE offset and step 1108 could be replaced by a step of checking if the tuning index is increased.

According to the above description, the calibrating circuit 1020 shown in FIG. 10 uses the wobble jitter to set the tuning index. However, other information could also be used to set the tuning index. Referring to FIG. 9, the decoder 910 is capable of providing error rate information when decoding the wobble signal WOBBLE. For an alternative embodiment of the optical disc drive 1000 shown in FIG. 10, the circuit architecture shown in FIG. 9 is implemented. That is, the calibrating circuit in this alternative design makes use of the error rate information to set the required tuning index. The same objective of locating the optimum TE offset is achieved.

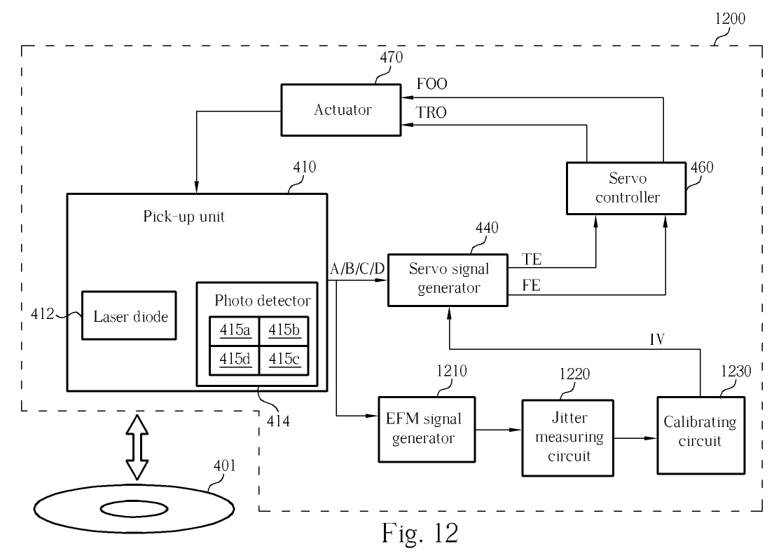

As to calibrating parameters for the tracking error signal TE, the present invention brings up another new calibration scheme. Please refer to FIG. 12. FIG. 12 shows a block diagram of an optical disc drive 1200 (e.g., a DVD drive) according to a fifth embodiment of the present invention.

In this embodiment, the optical disc drive 1200 includes an EFM signal generator 1210 for receiving detecting signals: A, B, C, and D. The EFM signal generator 1210 then generates an EFM data. A jitter measuring circuit (jitter meter) 1220 is positioned between the EFM signal generator 1210 and the calibrating circuit 1230, and used for measuring the jitter of the EFM data and then providing the jitter information to the calibrating circuit 1230. A TE offset is utilized by the servo signal generator 440 to compensate the tracking error signal TE. In an effort to optimize the tracking control, the TE offset should be properly calibrated. Therefore, the calibrating circuit 1230 cooperates with the jitter measuring circuit 1220 to tune the TE offset set to the servo signal generator 440.

During the calibration process, the calibrating circuit 1230 calculates a tuning index for each TE offset set to the servo signal generator 440 according to the calibration setting IV. The jitter information provided by the jitter measuring circuit 1220 is utilized by the calibrating circuit 1230 to set the tuning index. As the tuning index becomes smaller the TE offset approaches its optimum value. Based on this rule, the operation of calibrating the parameters for the tracking error signal TE (e.g., the TE offset) is detailed as follows.

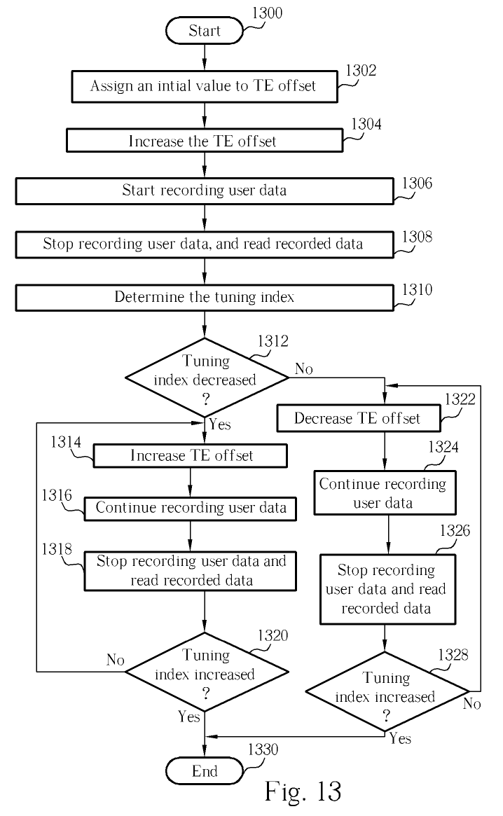

Please refer to FIG. 13, which is a flowchart illustrating operation of tuning the TE offset performed by the optical disc drive 1200 shown in FIG. 12. Tuning the TE offset includes following steps:

Step 1300: Start.

Step 1302: Assign an initial value to the TE offset.

Step 1304: Increase the TE offset.

Step 1306: Start recording user data.

Step 1308: Stop recording user data and then read the recorded data.

Step 1310: Determine the tuning index according to the recorded data read from the optical disc 401.

Step 1312: Is the tuning index decreased? If yes, go to step 1314; otherwise, go to step 1322.

Step 1314: Increase the TE offset.

Step 1316: Continue recording user data.

Step 1318: Stop recording user data and then reading the recorded data.

Step 1320: Is the tuning index increased? If yes, go to step 1330; otherwise, go to step 1314.

Step 1322: Decrease the TE offset.

Step 1324: Continue recording user data.

Step 1326: Stop recording user data and then reading the recorded data.

Step 1328: Is the tuning index increased? If yes, go to step 1330; otherwise, go to step 1322.

Step 1330: End.

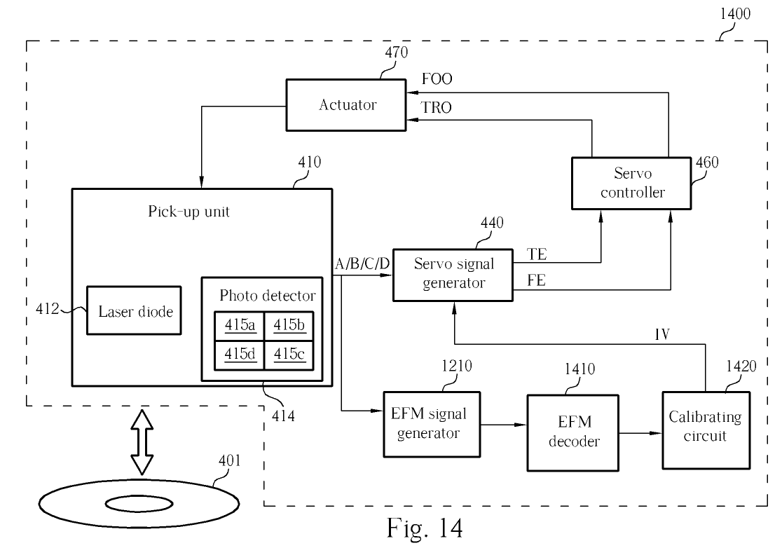

The flow as shown in FIG. 13 is similar to the flow as shown in FIG. 11 and further description is omitted here for brevity. According to the above description, the calibrating circuit 1230 uses the EFM jitter to set the tuning index. However, other information could also be used to set the tuning index. Please refer to FIG. 14, which is a block diagram of an optical disc drive 1400 (e.g., a DVD drive) according to a sixth embodiment of the present invention. Since the elements having the same name in the fifth embodiment and the sixth embodiment have the same function and operation, further description is omitted for the sake of brevity. The key difference between the fifth and sixth embodiments is that the calibrating circuit 1420 determines the tuning index according to information provided by the EFM decoder 1410 instead of the EFM jitter. That is, the calibrating circuit 1420 uses the error rate when the EFM decoder 1410 decoding the EFM data to set the tuning index. In this embodiment, a smaller tuning index provides for a more optimum the TE offset. According to the flow as shown in FIG. 13, the same objective of locating the optimum TE offset is achieved when the tuning index is set by the decoding error rate.

Both flows as shown in FIGS. 11 and 13 are real-time calibrations for the TE offset after the data recording is started. The key difference is the generation of the tuning index. As to the flow shown in FIG. 11, the tuning index is determined according to signals generated under write mode. Therefore, the data recording process is not interrupted when the tuning index is to be calculated. However, the tuning index is wobble-related, meaning that gathering the needed information to measure the tuning index takes a longer period. As to the flow shown in FIG. 13, the tuning index is determined according to signals generated under read mode. Therefore, the data recording process is interrupted when the tuning index is to be calculated. However, the tuning index is EFM-data-related, meaning that a significant bulk of data can be quickly gathered to measure the tuning index. As described above, the flow as shown in FIG. 11 is suitable for calibrating the TE offset under CAV recording, while the flow shown in FIG. 13 is suitable for calibrating the TE offset under ZoneCLV recording.

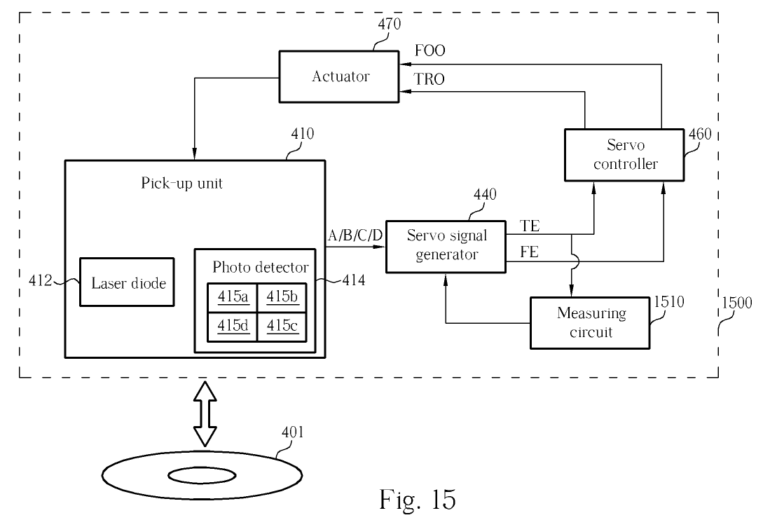

Please refer to FIG. 15, which is a block diagram illustrating an optical disc drive 1500 (e.g., a DVD drive) according to a seventh embodiment of the present invention. The optical disc drive 1500 is capable of calibrating the TE offset off-line. That is, the tracking control is not performed after the data recording process is started. At this condition, the track offset can be measured under write mode directly. The function of circuit 1510 is to measure the TE offset under recording and save the result to driver automatically. After this off-line calibration, driver will compensate the saved result to servo signal generator 440 directly. Since the elements of the same name in the first and seventh embodiments have the same function and operation, further description is omitted for the sake of brevity. Compared to the circuit architecture shown in FIG. 7, the optical disc drive 1500 as shown in FIG. 15 further includes a measuring circuit 1510 coupled to the servo signal generator 440 for measuring the tracking error signal TE outputted from the servo signal generator 440 to determine the TE offset. The functionally difference of FIG. 7 and FIG. 15 is obviously. FIG. 7 is on-line calibrating architecture by check wobble signal. This architecture could be applied to normal recording and reading. But the architecture of FIG. 15 is an off-line calibrating flow. This flow is applied at product-line to cover worse driver. Because some worse drivers without product-line calibration cannot normally read and record. So, the off-line and on-line calibrating flows can be regarded to complement with each other.

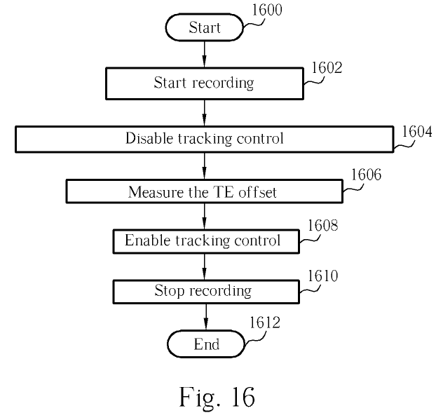

FIG. 16 is a flowchart illustrating operation of determining the TE offset off-line. The off-line operation performed by the optical disc drive 1500 includes following steps:

Step 1600: Start.

Step 1602: The optical disc drive 1500 starts recording test data onto the optical disc 401.

Step 1604: The servo controller 460 disables the tracking control.

Step 1606: The measuring circuit 1510 measures the tracking error signal TE to determined the TE offset.

Step 1608: The servo controller 460 enables the tracking control.

Step 1610: The optical disc drive 1500 stops recording test data onto the optical disc 401.

Step 1612: End.

It is known that the tracking control is a closed-loop control, making the estimated TE offset different from the actual TE offset due to the feedback. In this embodiment, the tracking control is disabled when the TE offset is being measured. Therefore, the measured TE offset under this condition represents the actual TE offset occurring via the tracking operation. Because the tracking control is disabled and the test data is not the user data to be recorded on the optical disc 401, step 1602 writes test data onto the lead-in area or lead-out area of the optical disc 401 according to a write power. Therefore, the measuring circuit 1510 determines the TE offset corresponding to the write power. Later, when a normal recording process is started to recording user data onto the optical disc 401 by the above write power, the measured TE offset can be used to accurately compensate the tracking error signal TE to improve the recording performance.

The present invention is capable of calibrating servo parameters (e.g., Kb, TE offset, FE offset, loop gain of the servo control, etc.) for a plurality of layers and calibrating servo parameters for a plurality of positions on the same layer. Take the servo parameter calibration of a dual-layer DVD for example. For a first layer of the dual-layer DVD, the servo parameter calibration is performed many times for a plurality of positions (tracks) on the first layer; for a second layer of the dual-layer DVD, the servo parameter calibration is performed many times for a plurality of positions (tracks) on the first layer. In addition, the present invention discloses calibrating the servo parameters through referring to index values (i.e., balance index and tuning index). The present invention makes use of characteristic of the reflected laser beam to measure these index values for tuning the servo parameters.

As to focusing parameter calibration, a plurality of parameter settings is tested in order to find an optimum setting for parameters Kb and TE offset. As to tracking parameter calibration, the present invention provides an on-line calibration for calibrating the TE offset after the normal user data recording is started and an off-line calibration for calibrating the TE offset before the normal user data recording is started. The on-line calibration can calibrate the TE offset on the fly, while the off-line calibration can accurately calibrate the TE offset applied to the normal user data recording.

When recording user data onto a specific track of a specific layer, proper servo parameters are used to compensate the servo control mechanism for the non-uniform die layer of the optical disc or the optical path deviation caused by the power increment. To sum up, the optical disc drive and related servo parameter calibration method of the present invention greatly improve the recording quality and the recording performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for calibrating a parameter utilized for determining a servo signal of an optical disc drive, the method comprising:
(a) adjusting the parameter;
(b) generating a first signal according to detecting signals outputted from one side of a photo detector;
(c) generating a second signal according to detecting signals outputted from the other side of the photo detector;
(d) generating an index value according to the first and second signals; and
(e) utilizing the parameter corresponding to the index as an optimum parameter for the servo signal if a criterion for the index value is satisfied.

2. The method of claim 1, wherein step (d) further comprises:
detecting a first DC level of the first signal;
detecting a second DC level of the second signal; and
determining the index value by a difference between the first and second DC levels.

3. The method of claim 2, wherein the criterion is the index value being a minimum of a plurality of index values generated from repeating steps (a), (b), (c), and (d) a plurality of times.

4. The method of claim 2, wherein step (d) further comprises:
determining a wobble signal according to the first and second signals; and
determining the index value by magnitude of the wobble signal.

5. The method of claim 4, wherein the criterion is the index value being a maximum of a plurality of index values generated from repeating steps (a), (b), (c), and (d) a plurality of times.

6. The method of claim 2, wherein step (d) further comprises:
determining a wobble signal according to the first and second signals; and
determining the index value by an error rate of decoding the wobble signal.

7. The method of claim 6, wherein the criterion is the index value being a minimum of a plurality of index values generated from repeating steps (a), (b), (c), and (d) a plurality of times.

8. The method of claim 1, wherein step (d) further comprises:
determining a wobble signal according to the first and second signals; and
determining the index value by jitter of the wobble signal.

9. The method of claim 1, further comprising:
detecting if the index value is increased as the parameter is increased; and
repeating step (a) for decreasing the parameter if the criterion for the index value is not satisfied and the index value is increased as the parameter is increased;
wherein the criterion is that the index value is increased as the parameter is decreased.

10. The method of claim 1, further comprising:
detecting if the index value is decreased as the parameter is increased; and
if the criterion for the index value is not satisfied and the index value is decreased as the parameter is increased, repeating step (a) for increasing the parameter;
wherein the criterion is that the index value is increased as the parameter is increased.

11. A method for determining a parameter utilized for determining a servo signal of an optical disc drive, the method comprising:
disabling a tracking control;
measuring the servo signal when the tracking control is disabled; and
determining the parameter according to the measured servo signal.

12. A method for calibrating a parameter utilized for determining a servo signal of an optical disc drive, the method comprising:
(a) adjusting the parameter;
(b) reading data from an optical disc;
(c) generating an index value according to the data; and
(d) utilizing the parameter corresponding to the index as an optimum parameter for the servo signal if a criterion for the index value is satisfied.

13. The method of claim 12, further comprising:
detecting if the index value is increased as the parameter is increased; and
if the criterion for the index value is not satisfied and the index value is increased as the parameter is increased, repeating step (a) for decreasing the parameter;
wherein the criterion is that the index value is increased as the parameter is decreased.

14. The method of claim 12, further comprising:
detecting if the index value is decreased as the parameter is increased; and
if the criterion for the index value is not satisfied and the index value is decreased as the parameter is increased, repeating step (a) for increasing the parameter;
wherein the criterion is that the index value is increased as the parameter is increased.

15. The method of claim 12, wherein step (c) further comprises:
determining the index value by EFM jitter of the data.

16. The method of claim 12, wherein step (d) further comprises:
determining the index value by an error rate of decoding the data.

17. A method for calibrating parameters for a servo signal of an optical disc drive, the method comprising:
(a) calibrating a first parameter for the servo signal when the optical disc drive accesses a first layer of an optical disc; and
(b) calibrating a second parameter for the servo signal when the optical disc drive accesses a second layer of an optical disc.

18. The method of claim 17, wherein, step (a) further comprises:
calibrating a third parameter for the servo signal when the optical disc drive accesses the first layer of an optical disc, the first and second parameters corresponding to different tracks on the first layer; and
step (b) further comprises:
calibrating a fourth parameter for the servo signal when the optical disc drive accesses the second layer of an optical disc, the second and fourth parameters corresponding to different tracks on the second layer.

19. A method for calibrating parameters for a servo signal of an optical disc drive, the method comprising:
calibrating a first parameter for the servo signal when the optical disc drive accesses a first track on a layer of an optical disc; and
calibrating a second parameter for the servo signal when the optical disc drive accesses a second track on the layer of the optical disc.

20. An optical disc drive capable of calibrating at least a parameter utilized for determining a servo signal, the optical disc drive comprising:
a servo signal generator for generating the servo signal;
a photo detector;
a signal generator, coupled to the photo detector, for generating a first signal according to detecting signals outputted from one side of a photo detector and for generating a second signal according to detecting signals outputted from the other side of the photo detector; and
a calibrating circuit, coupled to the signal generator and the servo signal generator, for adjusting the parameter set to the servo signal generator and generating an index value according to the first and second signals, wherein if a criterion for the index value is satisfied, the calibrating circuit sets the parameter corresponding to the index as an optimum parameter to the servo signal generator.

21. The optical disc drive of claim 20, wherein the calibrating circuit further detects a first DC level of the first signal;
detects a second DC level of the second signal; and
determines the index value by a difference between the first and second DC levels.

22. The optical disc drive of claim 20, wherein the criterion is the index value being a minimum of a plurality of index values generated from the calibrating circuit.

23. The optical disc drive of claim 20, further comprising:
a wobble circuit, coupled between the signal generator and the calibrating circuit, for determining a wobble signal according to the first and second signals; and
wherein the calibrating circuit determines the index value by magnitude of the wobble signal.

24. The optical disc drive of claim 23, wherein the criterion is the index value being a maximum of a plurality of index values generated from the calibrating circuit.

25. The optical disc drive of claim 20, further comprising:
a wobble circuit, coupled to the signal generator, for determining a wobble signal according to the first and second signals; and
a decoder, coupled to the wobble circuit and the calibrating circuit, for decoding the wobble signal;
wherein the calibrating circuit determines the index value by an error rate of the wobble signal decoding performed by the decoder.

26. The optical disc drive of claim 25, wherein the criterion is the index value being a minimum of a plurality of index values generated from the calibrating circuit.

27. The optical disc drive of claim 20, further comprising:
a wobble circuit, coupled to the signal generator, for determining a wobble signal according to the first and second signals; and
a jitter measuring circuit, coupled to the wobble circuit and the calibrating circuit, for measuring jitter of the wobble signal;
wherein the calibrating circuit determines the index value by jitter of the wobble signal.

28. The optical disc drive of claim 20, further comprising:
a wobble circuit, coupled to the signal generator, for determining a wobble signal according to the first and second signals; and
a decoder, coupled to the wobble circuit and the calibrating circuit, for decoding the wobble signal;
wherein the calibrating circuit determines the index value by an error rate of the wobble signal decoding performed by the decoder.

29. The optical disc drive of claim 20, wherein the calibrating circuit further detects if the index value is increased as the parameter is increased; if the criterion for the index value is not satisfied and the index value is increased as the parameter is increased, the calibrating circuit decreases the parameter; and the criterion is that the index value is increased as the parameter is decreased.

30. The optical disc drive of claim 20, wherein the calibrating circuit further detects if the index value is decreased as the parameter is increased; if the criterion for the index value is not satisfied and the index value is decreased as the parameter is increased, the calibrating circuit increases the parameter; and the criterion is that the index value is increased as the parameter is increased.

31. An optical disc drive capable of determining at least a parameter utilized for determining a servo signal, the optical disc drive comprising:
a servo signal generator for generating the servo signal;
a measuring circuit, coupled to the servo signal generator, for measuring the servo signal to determine the parameter according to the measured servo signal; and
a servo controller, coupled to the servo signal generator, capable of disabling a tracking control when the measuring circuit measures the servo signal.

32. An optical disc drive capable of calibrating at least a parameter utilized for determining a servo signal, the optical disc drive comprising:
a servo signal generator for generating the servo signal;
a data accessing circuit for reading data from an optical disc; and
a calibrating circuit, coupled to the servo signal generator and the data accessing circuit, for generating an index value according to the data, wherein if a criterion for the index value is satisfied, the calibrating circuit utilizes the parameter corresponding to the index as an optimum parameter for the servo signal.

33. The optical disc drive of claim 32, wherein the calibrating circuit further detects if the index value is increased as the parameter is increased; if the criterion for the index value is not satisfied and the index value is increased as the parameter is increased, the calibrating decreases the parameter; and the criterion is that the index value is increased as the parameter is decreased.

34. The optical disc drive of claim 32, wherein the calibrating circuit further detects if the index value is decreased as the parameter is increased; if the criterion for the index value is not satisfied and the index value is decreased as the parameter is increased, the calibrating circuit increases the parameter; and the criterion is that the index value is increased as the parameter is increased.

35. The optical disc drive of claim 32, further comprising:
a jitter measuring circuit, coupled to the data accessing circuit and the calibrating circuit, for measuring EFM jitter of the data;
wherein the calibrating circuit determines the index value by EFM jitter of the data.

36. The optical disc drive of claim 32, further comprising:
a decoder, coupled to the data accessing circuit and the calibrating circuit, for decoding the data;
wherein the calibrating circuit determines the index value by an error rate of the data decoding performed by the decoder.

37. An optical disc drive capable of calibrating parameters for a servo signal, the optical disc drive comprising:
a servo signal generator for generating the servo signal; and
a calibrating circuit, coupled to the servo signal generator, for calibrating a first parameter set to the servo signal generator for the servo signal when the optical disc drive accesses a first layer of an optical disc, and for calibrating a second parameter set to the servo signal generator for the servo signal when the optical disc drive accesses a second layer of an optical disc.

38. The optical disc drive of claim 37, wherein the calibrating circuit further calibrates a third parameter set to the servo signal generator for the servo signal when the optical disc drive accesses the first layer of an optical disc and calibrates a fourth parameter set to the servo signal generator for the servo signal when the optical disc drive accesses the second layer of an optical disc; the first and second parameters corresponding to different tracks on the first layer; and the second and fourth parameters corresponding to different tracks on the second layer.

39. An optical disc drive capable of calibrating parameters for a servo signal, the optical disc drive comprising:
a servo signal generator for generating the servo signal; and
a calibrating circuit, coupled to the servo signal generator, for calibrating a first parameter set to the servo signal generator for the servo signal when the optical disc drive accesses a first track on a layer of an optical disc, and for calibrating a second parameter set to the servo signal generator for the servo signal when the optical disc drive accesses a second track on the layer of the optical disc.
